(19) United States
(12) Patent Application Publication
(10) Pub. No.: US 2020/0012000 A1
(43) Pub. Date: Jan. 9, 2020

(54) APPARATUS FOR MEASURING RADIATION

(71) Applicant: Sensinite Oy, Vaasa (FI)

(72) Inventor: Risto ORAVA, Helsinki (FI)

(21) Appl. No.: 16/470,094

(22) PCT Filed: Dec. 14, 2017
(86) PCT No.: PCT/FI2017/050889

§ 371 Date: Jun. 14, 2019

(30) Foreign Application Priority Data
Dec. 16, 2016 (GB) 1621498.3

(51) Int. Cl. G01T 1/20; G01T 1/202; G01T 3/06

(52) U.S. Cl. CPC G01T 1/2006; G01T 3/06; G01T 1/202

(57) ABSTRACT

Disclosed is an apparatus for measuring radiation. The apparatus includes an at least partially optically transparent first element. The partially optically transparent first element includes at least a first group of clusters of particles, wherein the clusters of particles of the first group are arranged at a first distance from each other and the particles of clusters of the first group are capable of converting a first type of radiation at least partly to photons having a first characteristic band of wavelengths. The apparatus also includes a photo detector arranged to measure light intensity emitted from the first group of clusters of particles and a processor configured to use the measured light intensity to determine an amount of the first type of radiation. The at least partially optically transparent element is a polymer sheet.

### TECHNICAL FIELD

The present disclosure relates generally to radiation detection; and more specifically, to an apparatus for measuring radiation, and a method for manufacturing of optical elements to be used for such measurement of radiation.

### BACKGROUND

Radiation may include ionising radiation, such as gamma rays and x-rays; and low energy non-ionising radiation including microwaves and radio waves. It may be evident that people around the world are exposed to radiation on a daily basis. Such instances may include exposure to microwaves emitted by a microwave oven, x-rays emitted by an x-ray machine, radio waves emitted by radios and televisions, exposure to alpha particles, beta particles and neutrons from radioactive sources and so forth. It may also be evident that moderate exposure to the low energy non-ionising radiation may not be harmful to people, however, longer term exposure to even relatively low level of ionising radiation (such as alpha particles, beta particles and other electrically charged particles) or neutrons is considered as a radiation hazard. Therefore, detection of such harmful radiation is of paramount importance to ensure safety of people.

Spontaneous or induced emission of X-rays, gamma rays, alpha particles, beta particles or neutrons is characteristic to different atoms and their isotopes, and can be used to identify isotopes.

Radiation can be detected using radiation detectors such as Geiger counter, ionisation chamber, scintillation counter, neutron detector and so forth. The scintillation counter is a radiation detector that primarily comprises a scintillating material for detection of incident radiation. Generally, the scintillating material produces light in the form of photons, on interaction with incident radiation, which may be further detected and measured using appropriate hardware and software components to measuring the characteristic band of wavelengths corresponding to such photons. Conventional scintillating materials include organic liquids (for example, in liquid scintillation counting), monolithic transparent crystals such as anthracene, naphthalene, zinc sulphide, yttrium aluminium garnet, and so forth. However, conventional scintillating materials such as monolithic crystals suffer from the limitation of having a small sensitive area (or volume). Further, production of large crystals of scintillating materials (to increase the sensitive surface area) is challenging, for example, in terms of cost, manufacturing setup or complexity, and the like. Moreover, lack of homogeneity in the crystals due to presence of defects and precipitates may lead to trapping of charge carriers, resulting in non-uniform scintillating signals.

Therefore, in light of the foregoing discussion, there exists a need to overcome the aforementioned drawbacks associated with detection of radiation.

### SUMMARY

The present disclosure seeks to provide an apparatus for measuring radiation. The present disclosure also seeks to provide a method of manufacturing an at least partially optically transparent element comprising at least two clusters of particles. The present disclosure seeks to provide a solution to the existing problems associated with use of monolithic scintillating crystals in scintillation radiation detectors. An aim of the present disclosure is to provide a solution that overcomes at least partially the problems encountered in prior art, and provides a simple alternative to monolithic scintillating crystals and enables reliable detection of multiple types of radiation.

In one aspect, an embodiment of the present disclosure provides an apparatus for measuring radiation, the apparatus comprising
an at least partially optically transparent first element, comprising at least a first group of clusters of particles, wherein
   the clusters of particles of the first group are arranged at a first distance from each other;
   the particles of clusters of the first group are capable of converting a first type of radiation at least partly to photons having
   a first characteristic band of wavelengths;
a photo detector arranged to measure light intensity emitted from the first group of clusters of particles; and
a processor configured to use the measured light intensity to determine an amount of the first type of radiation wherein the at least partially optically transparent element is a polymer sheet.

In another aspect, an embodiment of the present disclosure provides a method of manufacturing an at least partially optically transparent element comprising at least two clusters of particles, the method comprising
arranging polymer granules on a supporting surface to form a sheet of polymer granules;
covering the sheet of polymer granules with a stencil comprising openings, the openings having a diameter and being arranged at a distance from each other;
arranging particles on top of the stencil to enable mixing of the particles with the polymer granules exposed via the openings of the stencil to create clusters of particles; and
forming the at least partially transparent element by applying an amount of heat for a duration of time.

Embodiments of the present disclosure substantially eliminate or at least partially address the aforementioned problems in the prior art, and enables simplified, reliable and cost effective detection of radiation.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of an environment for implementing an apparatus for measuring radiation, in accordance with an embodiment of the present disclosure;

FIG. 2 is a schematic illustration of an exemplary manufacturing setup for manufacturing a partially optically transparent element, in accordance with an embodiment of the present disclosure;

FIG. 3 is a schematic illustration of a partially optically transparent element, in accordance with an embodiment of the present disclosure;

FIG. 4 is a cross sectional view of the partially optically transparent element of FIG. 3 along an axis XX, in accordance with an embodiment of the present disclosure;

FIG. 5 is a schematic illustration of various stages of manufacturing a partially optically transparent element, in accordance with an embodiment of the present disclosure;

FIG. 6 is a schematic illustration of graphs depicting dependences of scintillation signals from disperse ZnSe(Al) and LGSO(Ce) scintillators as a function of the X-ray tube voltage at constant current of 0.395 mA with a reflector between the two elements and without a reflector;

FIG. 7 is an illustration of steps of a method for manufacturing a partially optically transparent element, in accordance with an embodiment of the present disclosure; and

FIG. 8 is a graph depicting radioluminescence spectra of an apparatus for measuring radiation, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides an apparatus for measuring radiation, the apparatus comprising
an at least partially optically transparent first element, comprising at least a first group of clusters of particles, wherein
   the clusters of particles of the first group are arranged at a first distance from each other;
   the particles of clusters of the first group are capable of converting a first type of radiation at least partly to photons having
   a first characteristic band of wavelength;
a photo detector arranged to measure light intensity emitted from the first group of clusters of particles; and
a processor configured to use the measured light intensity to determine an amount of the first type of radiation, wherein the at least partially optically transparent element is a polymer sheet.

In another aspect, an embodiment of the present disclosure provides a method of manufacturing an at least partially optically transparent element comprising at least two clusters of particles, the method comprising
arranging polymer granules on a supporting surface to form a sheet of polymer granules;
covering the sheet of polymer granules with a stencil comprising openings, the openings having a diameter and being arranged at a distance from each other;
arranging particles on top of the stencil to enable mixing of the particles with the polymer granules exposed via the openings of the stencil to create clusters of particles; and
forming the at least partially transparent element by applying an amount of heat for a duration of time.

The present disclosure provides an apparatus for measuring radiation and a method for manufacturing of optical elements to be used for such measurement of radiation. The present disclosure provides an alternative to monolithic scintillating crystals used for detection of radiation. Specifically, the present disclosure provides partially optically transparent elements having multiple clusters of particles (crystals), which can be used for radiation detection, hence the combination of the polymer sheet with the clusters can also be called a detector. The partially optically transparent elements do not include limitation of size of manufacture, and are efficient in terms of cost of manufacturing and manufacturing setup complexity. Therefore, the present disclosure provides simplified, reliable and cost effecting detection of radiation.

The apparatus comprises an at least partially optically transparent first element, comprising at least a first group of clusters of particles. The at least partially optically transparent first element may be a substrate, for example a rectangular sheet, for incorporating the first group of clusters of particles therein. In an example, the at least partially optically transparent first element may be completely transparent to allow substantially complete transmission of incident radiation. In another example, the at least partially optically transparent first element may be translucent to allow a portion of the incident radiation to be transmitted. Indeed, the apparatus comprises an optically transparent matrix material with crystal granules that convert the incoming particles into observable signals by absorbing radiation and emitting gammas/electrons that will subsequently cause luminescence light as the signal to be collected.

The at least partially optically transparent first element is a polymer sheet. The sheet may be made of thermoplastic or thermoset such as polyvinylchloride, polypropylene, silicones, polyurethane, and so forth. In an example, the polymer sheet may have a thickness of 0.05-10 millimetres. The thickness of the sheet can be for example 0.1-0.3 mm, 0.3-0.5 mm or 0.54.5 mm. The thickness can thus vary for example from 0.05, 0.08, 0.1, 0.2, 0.3, 0.4, 0.5, 0.6, 0.7, 0.8, 0.9, 1.0, 1.1, 1.2, 1.3, 1.4, 1.5, 1.8, 2.0, 2.4, 2.8, 3.0, 3.5, 4.0, 4.5, 5.0, 5.5, 6.0, 6.5, 7.0, 7.5, 8.0 or 8.5 mm up to 0.08, 0.1, 0.2, 0.3, 0.4, 0.5, 0.6, 0.7, 0.8, 0.9, 1.0, 1.1, 1.2, 1.3, 1.4, 1.5, 1.8, 2.0, 2.4, 2.8, 3.0, 3.5, 4.0, 4.5, 5.0, 5.5, 6.0, 6.5, 7.0, 7.5, 8.0, 8.5, 9.0, 9.5 or 10 mm.

In an embodiment, the first group of clusters of particles may comprise clusters of particles arranged in a specific geometry (or shape), for example, a circle in two dimensions- or three dimensions-geometry such as a cone. For example, each cluster of the clusters may include a diameter of 10 nanometres-10 millimetres, preferably 10 nanometres-100 micrometres, and more preferably 10 micrometres-100 micrometres. Further, each cluster of the clusters may have a diameter of 25 micrometres. It may be evident that the cluster of particles may be configured in other geometries, for example, rectangular, triangular, oval, polygonal, and so forth in two dimensions and pyramidal, cylindrical, cubical, and so forth in three dimensions.

The clusters of particles of the first group are arranged at a first distance from each other. In an example, the clusters of particles of the first group may be spaced apart from each other such that adjacent clusters of particles are separated by an equal distance from each other. Further, the clusters of particles of the first group may be arranged in a matrix (such as a rectangular array or grid) on the partially optically transparent first element. The matrix may have multiple rows and columns, and it may be evident that the number of rows and columns of the matrix may vary depending on the shape (and/or dimensions) of the partially optically transparent first element. For example, the clusters of particles of the first group may be arranged in a matrix comprising 10 rows and 5 columns. In another example, the clusters of particles of the first group may be arranged in a matrix comprising 15 rows and 15 columns. Alternatively, the clusters of particles of the first group may be arranged in a circular array, oval array, polygonal array or randomly in two or three dimensions on the at least partially optically transparent first element.

According to an embodiment, the clusters of particles of the first group may be arranged at a sufficient distance from each other to enable accurate detection of scintillation. In an example, the clusters of particles may be separated by a sufficient distance from each other to avoid avalanche effect, i.e. to avoid interaction of a photon emitted from a cluster with particles of adjacent clusters, thereby emitting further photons, resulting in inaccurate signal (or scintillation). In such instance, the clusters may be separated by enough distance to enable discrimination of scintillation at individual clusters, such as, detection of location where the incident radiation contacts the partially optically transparent first element.

In one embodiment, the distance between clusters is 1-100 times of diameter of both clusters, preferably 2-10 times of diameter of both clusters, and more preferably 3-5 times of diameter of both clusters. For example, the distance between two adjacent clusters of same diameter may be 4 times of diameter of a cluster.

Some examples of different characteristics are given in the below Table 1.

TABLE 1

| | | relative light | minimal distance | spatial |
|---|---|---|---|---|
| particle | sheet | yield | between adjacent | resolution, |
| size | thickness | [% of ZnSe | clusters | [line |
| [μm] | [mm] | crystal] | [μm] | pairs/mm] |
| 25-40 | 0.1-0.3 | up to 30 | 40 | 6-7 |
| 40-120 | 0.3-0.5 | up to 55 | 120 | 4-5 |
| 120-200 | 0.5-1.5 | up to 80 | 200 | 2-3 |

The scintillator materials used as the particle clusters, the particle sizes, cluster dimensions, distances between the dusters, polymer sheet thickness are varied according to the type and energies of the incident particles/radiation to be detected.

According to an embodiment, the low energy X-rays (20-80 key) and 5 MeV alphas detector is based on ZnS:Ag, ZnSe:Te scintillators. In another embodiment, the high energy X-Rays (60-140 key) detector is based on LGSO and ZWO scintillators. In yet another embodiment, the X-Rays detector can be based on GAGG:Ce scintillators. For detecting fast neutrons and gammas, it is possible to use ¹⁵⁷Gd containing scintillators or ZnSe scintillators.

The thickness of the polymer sheet for detecting alpha can be for example 10 μm, while the thickness for detecting gamma can be 1 mm, etc. Indeed, concerning the thickness of the polymer sheet, it depends on the incident particle type. The thickness increases in the following order: thin for thin for alphas, thicker for betas, still thicker for gammas, and the thickest for neutrons.

According to an embodiment, the particles of clusters of the first group are made of a scintillating material of a first type. The scintillating material may be a material that exhibits scintillation (or luminescence) upon excitation by incident radiation. In such instance, the scintillating material absorbs energy from incident radiation and reaches an excited state (such as a state of higher energy). Further, the scintillating material emits, the absorbed energy, as a photon (for example, to return to its ground state or a state of lower energy) upon decay of the excited state.

In one embodiment, the particles of clusters may be crystals (in granular form) having same composition as other particles of the group of clusters. For example, a cluster of particles may comprise multiple crystals of same scintillating material (or chemical composition). In an example, the cluster of particles may comprise 100 crystals of a scintillating material. Further, such crystals may have a diameter of 1-100 micrometres.

In an embodiment, the scintillating material may be selected from group of zinc selenide, zinc sulphide, gadolinium fine aluminium gallate, lutetium-yttrium oxyorthosilicate, lutetium-gadolinium oxyorthosilicate, cadmium telluride, and cadmium zinc telluride. The scintillating material is selected based on the incident particles or quanta. For example, ZnS crystals are used for alpha particles, ZnSe crystals for gamma particles, and Cd or Gd containing elements are used for neutrons.

The particles of clusters of the first group are capable of converting a first type of radiation at least partly to photons having a first characteristic band of wavelengths. The first type of radiation causes the particles of clusters of the first group to reach an excited state. Further, the photons emitted upon decay (for example, after few nanoseconds) of the excited state of the particles of clusters of the first group may include the first characteristic band of wavelengths. A characteristic band of wavelengths can refer to spectrum of light with for example one or more peaks at certain wavelengths.

In an embodiment, the type of radiation may be selected from group of X-rays, gamma-rays, beta-rays, alpha radiation, charged particles, and neutrons. For example, the particles of clusters of the first group may include cadmium zinc telluride (CdZnTe) and accordingly capable of converting gamma radiation at least partly to photons having the first characteristic band of wavelengths. It may be evident that the band of wavelengths of photons emitted after converting a specific type of radiation may be dependent on the scintillating material of the particles of clusters and lattice structure of such particles.

According to an embodiment, the at least partially optically transparent first element comprises a second group of clusters of particles, wherein the clusters of particles of the second group are arranged at a second distance from each other. The second group of clusters of particles may include similar geometrical configuration as the first group of clusters of particles, such as a circle (in two dimensions) or cone (in three dimensions). Alternatively, the second group of clusters of particles may comprise clusters of particles that are configured in a different geometry, such as oval or polygonal. Also, it may be evident that each cluster of the clusters of particles of the second group may have same or different diameter compared to the clusters of particles of the first group. For example, the clusters of particles of the second group may be bigger or smaller than the clusters of particles of the first group. In an example, each of the clusters of particles of the second group may have a diameter of 50 micrometres.

In one embodiment, the clusters of particles of the second group are arranged at a second distance from each other, which may be or may not be same as the first distance. For example, the partially optically transparent first element may comprise equally spaced apart alternating rows (or columns) of the clusters of particles of the first group and the clusters of particles second group. In another example, the clusters of particles of the second group may be arranged in voids (or spaces without a cluster) formed by the clusters of particles of the first group. In yet another example, the partially optically transparent first element may include the clusters of particles of the first group in one half and the second group in another half. In such instances, the clusters of particles of the first group and the second group may be separated by a sufficient distance from each other to enable discrimination of scintillation at individual dusters.

In an embodiment, the particles of dusters of the second group are capable of converting a second type of radiation at least partly to photons having a second characteristic band of wavelengths. For example, the particles of dusters of the second group may be made of lutetium-gadolinium oxyorthosilicate (LGSO) and accordingly capable of converting neutrons at least partly to photons having a second characteristic band of wavelengths. The particles of clusters of the second group are thus different from the particles of clusters of the first group, and both can be selected from the same list of particles, as given above and below. The same applies to particles of clusters of any further group, as discussed below.

In one embodiment, the particles of clusters of the second group are made of a scintillating material of a second type. The particles of clusters of the second group may comprise crystals (in granular form) that may have a diameter of 1-100 micrometres.

In an embodiment, the apparatus further comprises an at least partially optically transparent second element comprising at least a third group of clusters of particles. The partially optically transparent second element may be a substrate (such as the partially optically transparent first element), for example, a rectangular sheet, for incorporating the third group of clusters of particles therein. Further, the partially optically transparent second element may be a polymer sheet having the same thickness, density and dimensions as the partially optically transparent first element. This may enable easy arrangement of the partially optically transparent first element and the second element when placed on top of each other. Alternatively, the partially optically transparent second element may have different thickness, density and dimensions compared to the partially optically transparent first element.

In one embodiment, optically conducting glue (such as a liquid optically clear adhesive or LOCA) may be used to affix the partially optically transparent first element and the partially optically transparent second element on top of each other.

In one embodiment, the third group of clusters of particles may comprise clusters of particles that are configured to have same geometry as the first group or the second group of clusters of particles, for example, a circle. Alternatively, the third group of clusters of particles may include different geometry, for example, an oval or polygonal. Further, each cluster of the clusters of particles of the third group may have same or different diameter compared to the first group and the second group of clusters of particles. In an example, each of the clusters of particles may include a diameter of 75 micrometres.

In one embodiment, the clusters of particles of the third group are arranged at a third distance from each other. The third distance may be same as the first distance or the second distance, or alternatively, the third distance may be different from the first distance and the second distance. Further, the clusters of particles of the third group may be arranged in a matrix or alternatively, may be arranged randomly on the partially optically transparent second element.

According to an embodiment, the particles of clusters of the third group are capable of converting a third type of radiation at least partly to photons having a third characteristic band of wavelengths. For example, the third type of radiation may be alpha particles.

In one embodiment, the particles of the clusters of third group are made of a scintillating material of a third type. The scintillating material of the third type may be different from the scintillating material of the first type and the second type. For example, the particles of the clusters of the third group may be made of zinc sulphide (ZnS) and accordingly, may be capable of converting alpha particles at least partly to photons having a third characteristic band of wavelengths.

According to one embodiment, the at least partially optically transparent second element further comprises a fourth group of clusters of particles. The fourth group of clusters of particles may include geometry as the third group of clusters of particles, such as a circle; alternatively the fourth group of clusters of particles may include different geometry, such as a rectangle. Further, the clusters of particles of the fourth group may have same diameter as the clusters of particles of the third group. Alternatively, the clusters of particles of the fourth group may have a different diameter from the clusters of particles of the third group, for example, 90 micrometres.

In an embodiment, the clusters of particles of the fourth group are arranged at a fourth distance from each other. The clusters of particles of the fourth group may be arranged at same distance from each other as the clusters of particles of the third group; alternatively, the clusters of particles of the fourth group may be arranged at a different distance compared to the third distance. Further, the clusters of particles of the fourth group may be arranged in a matrix. Also, the clusters of particles of the fourth group may be arranged in a matrix such that a row (or column) of the matrix may comprise same number of clusters of particles as number of clusters of particles in a row (or column) of the third group. Alternatively, the row (or column) of the matrix may comprise different number of clusters of particles compared to the number of clusters of particles in the row (or column) of the third group. Further, the clusters of particles of the fourth group may be arranged randomly on the partially optically transparent second element. It may be evident that in such instances, the clusters of particles of the fourth group and the clusters of particles of the third group may be separated by a sufficient distance from each other to enable discrimination of scintillation at individual clusters.

In one embodiment, the particles of clusters of the fourth group are capable of converting a fourth type of radiation at least partly to photons having a fourth characteristic band of wavelengths. For example, the fourth type of radiation may be beta particles.

According to an embodiment, the particles of the clusters of fourth group are made of a scintillating material of a fourth type. The particles of the clusters of fourth group may be crystals (in granular form), having a specific chemical composition such as zinc selenide (ZnSe).

In one embodiment, the particles of clusters of the fourth group may be capable of converting different type of radiation, such as beta particles, into photons having a fourth characteristic band of wavelengths. For example, the particles of the clusters of the fourth group may be made zinc selenide (ZnSe) and may be capable of converting beta particles into photons having a fourth characteristic band of wavelengths.

In an embodiment, the partially optically transparent first element and/or the second element may comprise different group of clusters of particles (such as the first and second group of clusters of particles, or the third and fourth group of clusters of particles).

In another embodiment, the partially optically transparent first element and/or the second element may comprise only one group of clusters of particles (such as the first group of clusters of particles). Further, the particles of clusters of the group may be made of a scintillating material that is capable of converting two different types of radiation at least partly to photons having different characteristic bands of wavelengths. In an example, the particles of clusters of the group may be made of cadmium telluride (CdTe) and may be capable of converting gamma radiation and neutrons at least partly to photons having different characteristic bands of wavelengths.

In one embodiment, the partially optically transparent first element and/or the partially optically transparent second element may comprise additional groups of clusters of particles (such as a fifth group of clusters of particles). The clusters of particles of the fifth group may include same or different geometry as compared to one of the first group, second group, third group or fourth group of clusters of particles. Also, the clusters of particles of the fifth group may be arranged at same or different distance from each other as compared to the first group, second group, third group or fourth group of clusters of particles. Further, the particles of clusters of the additional groups may be made of a scintillating material that is capable of converting same or different type of radiation as the first group, second group, third group or fourth group of clusters of particles, at least partly to photons having a different characteristic band of wavelengths. For example, the particles of clusters of the fifth group may be made of lutetium-yttrium oxyorthosilicate and may be capable of converting X-ray at least partly to photons having a different characteristic band of wave lengths.

According to an embodiment, the apparatus may comprise of additional partially optically transparent elements, for example, a partially optically transparent third element. In such instance, the partially optically transparent third element may comprise at least the fifth group of clusters of particles.

According to an embodiment, more additional partially optically transparent elements may be added to the apparatus as layers (or other combinations) without departing from the scope of the invention, to enable multiple energy response (for example, responses to low energy gamma radiation and high energy gamma radiation), discrimination of different types of incident radiation (such as x-rays, gamma-rays, neutrons, alpha particles and so forth), to improve detection efficiency of the apparatus, and so forth.

In an embodiment, the partially optically transparent elements may include crystals of scintillating material dispersed within a substrate instead of clusters of particles. In such instance, the crystals may be uniformly distributed in the partially optically transparent element (such as a polymer sheet). In an example, the crystals may be dispersed within a polymer sheet such that the crystals constitute at least 50% of volume of the polymer sheet. It may be evident that amount of crystals in the partially transparent element may be different. In an example, the amount of crystals in the partially transparent element may be varied to obtain higher detector quantum efficiency (ratio of incident photons to converted photoelectrons).

In one embodiment, crystals of different scintillating materials may be combined and dispersed within a substrate. For example, such combination of crystals of different scintillating materials may allow enhancement of position (or energy) resolution of different types of incident radiation, discrimination (or detection) between different types of incident radiation (such as gamma rays, X-rays, alpha particles and neutrons), and so forth.

According to an embodiment, the clusters of particles are arranged in a form selected from a circle, a rectangle, a cone, a pyramid and a matrix. The clusters of particles can thus be in a two-dimensional deposition, such as in the shape of a circle, rectangle, and others. The clusters of particles can also be in a three-dimensional deposition, in the shape of for example a cone, pyramid, and others. The clusters of particles can also be organised in a N×M matrix, whereby the distance between the clusters and size of the clusters can be adjusted to tune the detection to specific energy resolution and sensitivities. In case there are several types of groups of dusters of particles, the various groups can have the same or a different arrangement.

The apparatus also comprises a photo detector arranged to measure light intensity emitted from the first group of clusters of particles. The photo detector may be operable to absorb the converted photons (or light) from the partially optically transparent first element and the partially optically transparent second element, and convert them into electrons. The converted electrons yield a current that may be analysed to obtain light intensity of the incident radiation. In an example, the photo detector may comprise a charge-coupled device (CCD) or a semiconductor device (such as photodiode). In another example, the photo detector may be operable to detect specific wave lengths (such as a wave length dedicated photo detector) or may be operable to detect wave lengths over an entire range to measure a characteristic band of wave lengths. In yet another example, the photo detector may be a large area photo detector that may be operable to detect converted photons over complete area of the partially optically transparent second element (and/or the partially optically transparent first element), or it may be a matrix photo detector that may be operable to detect the converted photons in portion of the area of the least partially optically transparent second element (and/or least partially optically transparent first element).

According to an embodiment, the photo detector is also arranged to measure light intensity emitted from the second group, the third group and the fourth group of the clusters of particles. Further, the photons that are emitted by the second group, the third group and the fourth group of the clusters of particles may be detected by the photo detector. The photo detector may be configured to convert the photons into electrons (or photoelectrons). Furthermore, the electrons may yield a current that may be converted to a digital signal. The digital signal may be further processed and analysed to obtain the light intensity of the light (or photons) emitted from the second group, the third group and the fourth group of the dusters of particles.

In an embodiment, optical coupling of the photo detector with one of the partially optically transparent first and second element may be achieved using an optical coupler element, such as a photo condenser. The optical coupler element may be operable to direct (or focus) the photons emitted from the partially optically transparent second element to the photo detector. In an example, the photo condenser may comprise fibre optics.

According to an embodiment, the photo detector is arranged to measure the light intensity from at least two groups of the clusters of particles independently from each other. For example, the photo detector may be coupled to the partially optically transparent first element and the second element via the optical coupler element. Accordingly, the photo detector may be arranged to measure the light intensity from at least one group of the clusters of particles of the partially optically transparent first element (such as the first group of clusters of particles) and at least one group of the clusters of particles of the second element (such as the third group of clusters of particles). Alternatively, the photo detector may be coupled to one of the partially optically transparent elements, such as the partially optically transparent first element. Accordingly, the photo detector may be arranged to measure the light intensity from both groups of clusters of particles (such as the first group and second group of clusters of particles) of the first element.

The apparatus further comprises a processor configured to use the measured light intensity to determine an amount of the first type of radiation. The light intensity measured by the photo detector may be received by the processor (such as a central processing unit). Further, the processor may be configured to perform analysis of the received light intensity. For example, the processor may be configured to convert the light intensity received from the photo detector to an amount of the first type of radiation. In an example, the amount of the first type of radiation may be indicated in gray/hour (gy/h). In another example, the amount of the first type of radiation may be indicated in sievert/hour (or sv/h). Similarly, the processor may be configured to convert the light intensity received from the photo detector to an amount of the second type, the third type and the fourth type of radiation. In an embodiment, similarly, the processor is configured to use the measured light intensity from the second group, the third group, and the fourth group of clusters of particles to determine an amount of the second type, the third type and the fourth type of radiation. Also, the light intensity emitted from the second group, the third group and the fourth group that is detected by the photo detector may be received by the processor. Further, the processor may be configured to use the light intensity emitted from the second group, the third group and the fourth group of clusters of particles to determine an amount of the second type, the third type and the fourth type of radiation. Further, the processor may be configured to measure light intensity for a range of wavelengths to measure a characteristic band of wavelengths.

The present apparatus measures light intensity emitted from the different group of clusters of particles. Indeed, different types of radiation make the clusters of particles emit different amounts of light, leading to different light intensity. For example, alpha radiation will release a large amount of light (having large electrical charge, they ionise most). Furthermore, the amount of light released will also depend on the momentum of the incoming particle: the slower the particle, the more ionisation, i.e. more light. Gamma radiation is a special case, as it needs a conversion material that is efficient in releasing secondaries that in turn create photons as a signal. Also neutron irradiation represents a special case, and requires its own specific conversion materials. The amount of light released will depend on the conversion material, the neutron energy and the geometry. Examples of suitable clusters of particles for each type of irradiation have been given in this description.

In one embodiment, the amount of the first type of radiation may be further sent by the processor for further analysis. For example, the amount of the first type of radiation may be sent via a communication network (for example, long range communication network such as wireless local area network) to a server. The server may be associated with a third-party service, and the third-party service may be operable to further process and analyse the amount of the first type of radiation. In an example, the analysis may comprise of determination of whether the amount of first type of radiation exceeds a threshold (such as a safety limit).

According to an embodiment, the photo detector and the processor are further configured to measure timing of photons emitted from the clusters of particles.

The present disclosure also provides a method of manufacturing an at least partially optically transparent element comprising at least two clusters of particles. For example, the at least partially optically transparent element may be the partially optically transparent first element described herein above. Further, the at least two clusters of particles may comprise clusters of particles of the same group, such as the clusters of particles of first group (or the second group). Alternatively, the at least two clusters of particles may comprise the clusters of particles of different groups, such as the clusters of particles of the first group and the second group. Similarly, the at least partially optically transparent element may include the second element having the clusters of particles of the third and/or fourth group.

The method comprises arranging polymer granules on a supporting surface to form a sheet of polymer granules (or substrate). The polymer granules may comprise granules of material that the partially optically transparent first element is made of, such as plastic granules. In an example, the polymer granules may be polyvinylchloride granules. In another example, the polymer granules may be polyurethane granules. Further, the polymer granules may be arranged on the supporting surface to form the sheet of polymer granules with thickness of 5-10 millimetres.

In an embodiment, the supporting surface may be flat. For example, the supporting surface may be a flat plate (or tray) with dimensions equivalent to the required dimensions for the partially optically transparent element.

The method further comprises covering the sheet of polymer granules with a stencil comprising openings, the openings having a diameter and being arranged at a distance from each other. The stencil may be a sheet of plastic, metal or the like, and may comprise openings (such as holes) that are arranged in a matrix. It may be evident that the openings and their arrangement may correspond to the required characteristics, such as shape, dimension and locations, of the clusters of particles. The stencil may be placed on the sheet of polymer granules.

The method also comprises arranging particles on top of the stencil to enable mixing of the particles with the polymer granules exposed via the openings of the stencil to create clusters of particles. The particles may comprise particles of clusters of at least one of the first, second, third or fourth group (such as the crystals of scintillating material). The particles are arranged (spread or distributed evenly) on top of the stencil, to enable the particles to fall on the sheet of polymer granules. Further, this enables in mixing of the particles with the polymer granules exposed via the openings of the stencil to create clusters of particles in required locations. In an example, the stencil may comprise a matrix of circular openings. In such instance, circular (or cylindrical) clusters of particles will be formed on the sheet of polymer granules.

In an embodiment, the method may comprise of arranging particles on top of multiple stencils comprising of openings of different dimensions (or diameters). In an example, the particles are arranged on top of a stencil comprising of openings with diameter of 10 millimetres, to enable the particles to fall on the sheet of polymer granules. Further, the stencil may be sequentially replaced with other stencils comprising of openings with diameters of 8 millimetres, 6 millimetres, 4 millimetres, 2 millimetres and so forth, and the particles may be arranged on top of the stencils to enable the particles to fall on the sheet of polymer granules. It may be evident that in such instance, the clusters of particles formed may have a conical structure (comprising of multiple layers of clusters of particles of different diameters).

In one embodiment, the method comprises applying vibrations to the supporting surface during the manufacturing. The vibrations may be applied to the supporting surface to enable uniform distribution of the particles with polymer granules. Further, in instances of the particles and the polymer granules having different molecular weights, vibrations may be applied to manage distribution of component with higher molecular weight (for example, the particles) along a direction (such as x-, y- and z-directions). It may be evident that, the amount of mixing of the particles with the polymer granules, such as mixing on surface level or throughout the thickness of the partially optically transparent element, may be controlled based on the applied vibrations.

The method further comprises forming the at least partially transparent element by applying an amount of heat for a duration of time. The supporting surface comprising the sheet of polymer granules and the clusters of particles may be introduced to a heat source, such as a heating oven (or an industrial oven). The heat source may be configured to apply an amount of heat to the supporting surface comprising the sheet of polymer granules and the dusters of particles, for a duration of time, to form the partially transparent element.

According to an embodiment, the heat source may enable polymerisation of monomer granules that may be used to form the sheet of polymer granules.

In an embodiment, the at least optically partially transparent element is further formed in a form of concave, spherical or curved form factor. Specifically, the supporting surface may be configured to have such geometry (concave, spherical or curved form factor) for forming such partially transparent element.

In one embodiment, a curing agent (such as an inorganic isocyanate) may be mixed with the particles before arrangement of the particles on the stencil.

In an embodiment, the stencil may be removed from the sheet of polymer granules before introducing the supporting surface to the heat source.

In one embodiment, the method may comprise selecting crystals to form the clusters of particles, and also performing quality control of the crystals prior to selection. In such instance, the crystals may be subjected to surface cleaning to remove impurities or defects that may be caused due to impurities. The crystals may be classified according to characteristics such as light yield (amount of light obtained per amount of energy provided) and afterglow (amount of scintillation light sustained for a duration of time after decay of excited state). For example, the crystals may be classified for different applications depending on their light yield characteristics. Further, the method may comprise grinding the crystals using a mortar (such as a mechanical mortar) to obtain a crystalline powder. Moreover, the crystalline powder may be fractioned into various sizes using a sieve (such as an oscillating sieve).

In one embodiment, the method may further comprise preparing the supporting surface, such as cleaning the supporting surface. Further, the supporting surface may be used for mixing the crystalline powder with the polymer granules. Further, the supporting surface may be introduced to the heat source to obtain a partially optically transparent element.

In an embodiment, the crystalline power may be mixed with monomer granules. Further, a curing agent (such as an inorganic isocyanate) may be added to the mixture before introduction of the supporting surface to the heat source, to enable polymerisation of the monomer granules.

In alternative embodiment, the method might comprise arranging particles on top of the sheet of polymers using dispenser to arrange an amount of particles to form clusters of particles.

The polymer sheet can be manufactured with common industrial manufacturing processes. Depending on the chosen polymer related to the required mechanical and optical properties, the most suitable is adapted. If the polymer is a thermoplastic polymer, the most common manufacturing process is injection molding. In this process the polymer or the composition is heated up and injected into a mold of a desired geometry, to form a matrix. The material with scintillation properties is preferably also injected with a similar process as the compounded matrix. The distribution of the counter parts is described in other parts of the description.

If the chosen polymer is a thermoset polymer, the most common manufacturing process is reaction in mold (RIM). This process is most often performed at room temperature. The material with scintillation properties is preferably mixed with a similar thermoset compound to achieve good bonding between both parts.

There are cases when the polymer could be either thermoplastic or thermoset material and the material with scintillation properties the other material (i.e. if the polymer is thermoplastic, the material with scintillation properties is thermoset, and vice versa).

### DETAILED DESCRIPTION OF THE DRAWINGS

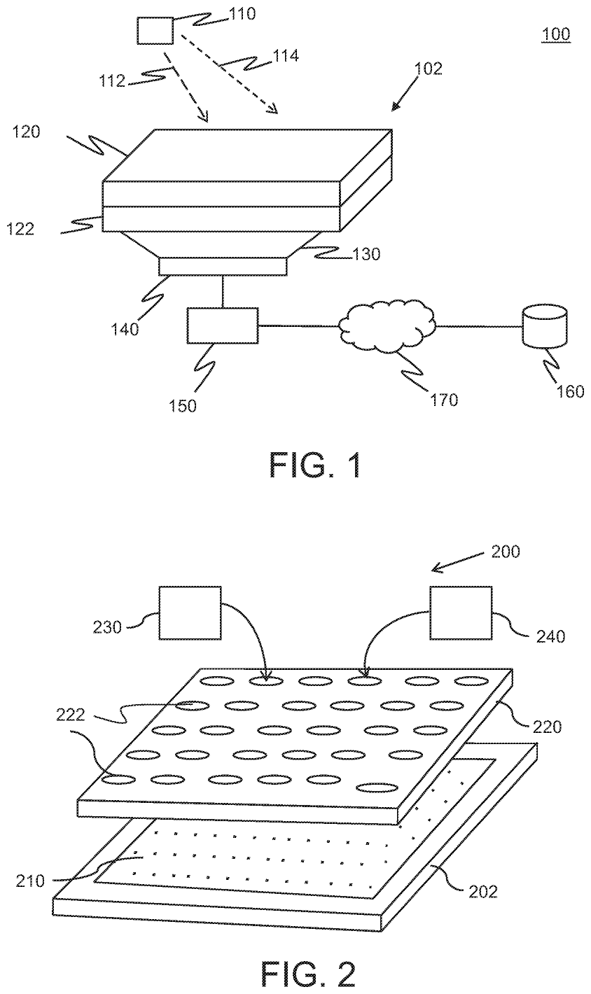

Referring to FIG. 1, illustrated is a schematic illustration of an environment 100 for implementing an apparatus 102 for measuring radiation, in accordance with an embodiment of the present disclosure. As shown, the environment 100 includes a radiation source 110, for providing incident radiation to be measured using the apparatus 102. The radiation source 110 is shown to emit radiation, for example gamma radiation 112 and neutrons 114. The apparatus 102 includes at least one partially optically transparent element, such as a partially optically transparent first element 120 and a partially optically transparent second element 122 arranged on top of the partially optically transparent first element 120. The partially optically transparent first and second elements 120 and 122 are capable of converting different types of radiation at least partly to photons having different characteristic bands of wavelengths. For example, the first and second partially optically transparent elements 120 and 122 are capable of converting the gamma radiation 112 and the neutrons 114 at least partly to photons (emitted due to decay of an excited state of the of particles of clusters on the partially optically transparent elements) having a first and a second characteristic bands of wave lengths, respectively.

The apparatus 102 also includes an optical coupler element 130 operatively coupled to the first and second partially optically transparent elements 120 and 122; and a photo detector 140 arranged to measure light intensity of the photons emitted from the first and second partially optically transparent elements 120 and 122. The optical coupler element 130 enables in transmitting the photons to the photo detector 140. The apparatus 102 also includes a processor 150, operatively coupled to the photo detector 140, and configured to use the measured light intensity (associated with the emitted photons) to determine amount of the type of radiation, such as the amount of the gamma radiation and neutrons 112 and 114, emitting from the radiation source 110. The environment 100 also includes a server 160, communicably coupled to the processor 150 using a communication network 170, operable to further process and analyse the measured light intensity. The processor 150 is configured to use the measured light intensity for associated over a range of light wavelengths to generate a characteristic band of wavelengths.

Referring to FIG. 2, illustrated is a schematic illustration of an exemplary manufacturing setup 200 for manufacturing a partially optically transparent element, in accordance with an embodiment of the present disclosure. Specifically, the manufacturing setup 200 is associated with the partially optically transparent elements, such as the partially optically transparent first and second elements 120 and 122 of the apparatus 102 of FIG. 1. As shown, the manufacturing setup 200 includes a supporting surface 202 (such as a tray), and granules of a polymer 210 placed on the supporting surface 202 to form a sheet of polymer granules. The manufacturing setup 200 also includes a stencil 220 having a plurality of openings (or holes) 222. The stencil 220 is adapted to be placed on top of the sheet of polymer granules 210. The manufacturing setup 200 further includes a container 230 for crystals of scintillating material (to be arranged on top of the stencil 220). The crystals from the container 230 are accordingly introduced through the holes 222 to mix with the polymer granules 210. The manufacturing setup 200 also includes a container 240 for containing a mixture of crystals of scintillating material and a curing agent. The mixture from the container 240 is also introduced through the holes 222 to mix with the polymer granules 210 to form the partially optically transparent element.

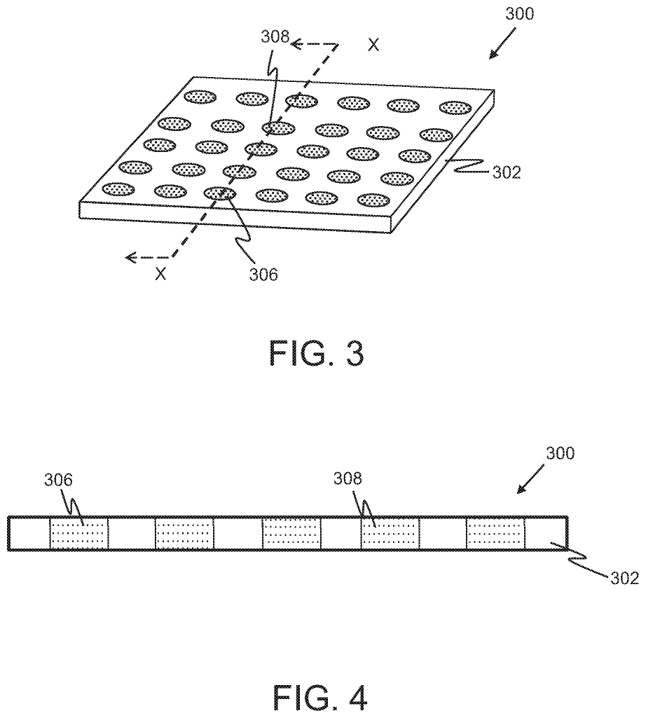

Referring to FIG. 3, illustrated is a schematic illustration of a partially optically transparent element 300 (such as the partially optically transparent first and second elements 120 and 122 of the apparatus 102 of FIG. 1), in accordance with an embodiment of the present disclosure. As shown, the partially optically transparent element 300 comprises a polymer sheet 302, and a group of clusters of particles, such as the clusters 306 and 308. Further, the clusters 306 and 308 are arranged at a distance from each other, and comprise particles capable of converting a radiation at least partly to photons having a characteristic band of wavelengths.

Referring to FIG. 4, illustrated is a cross sectional view of the partially optically transparent element 300 of FIG. 3 along an axis XX, in accordance with an embodiment of the present disclosure. The partially optically transparent element 300 comprises the polymer sheet 302 and the group of clusters of particles, such as the clusters 306 and 308. The clusters 306 and 308 shown are constituted by a mixture of crystals of the scintillating material and polymer granules.

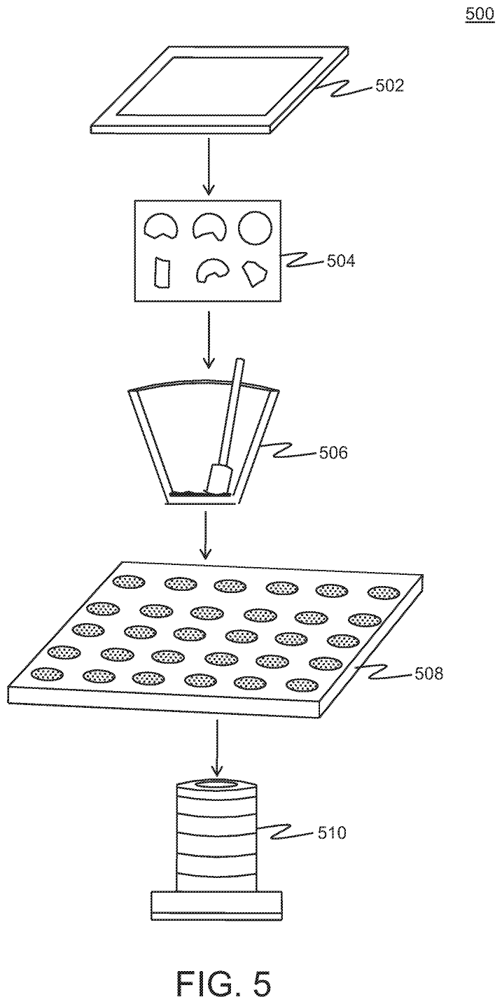

Referring to FIG. 5, illustrated is a schematic illustration of various stages 500 of manufacturing a partially optically transparent element (such as the partially optically transparent element 300 of FIG. 3), in accordance with an embodiment of the present disclosure. As shown, the various stages 500 include a stage 502, which includes preparing a supporting surface (such as the supporting surface 202 of FIG. 2) for example cleaning the supporting surface. At stage 504, selection and classification of crystals (for different applications) is performed. At stage 506, crystals are ground using a mortar to obtain a crystalline power. At stage 508, fractioning the crystalline powder into various sizes is performed using a sieve. At stage 510, the partially optically transparent element is formed (for example, by using the manufacturing setup 200 of FIG. 2).

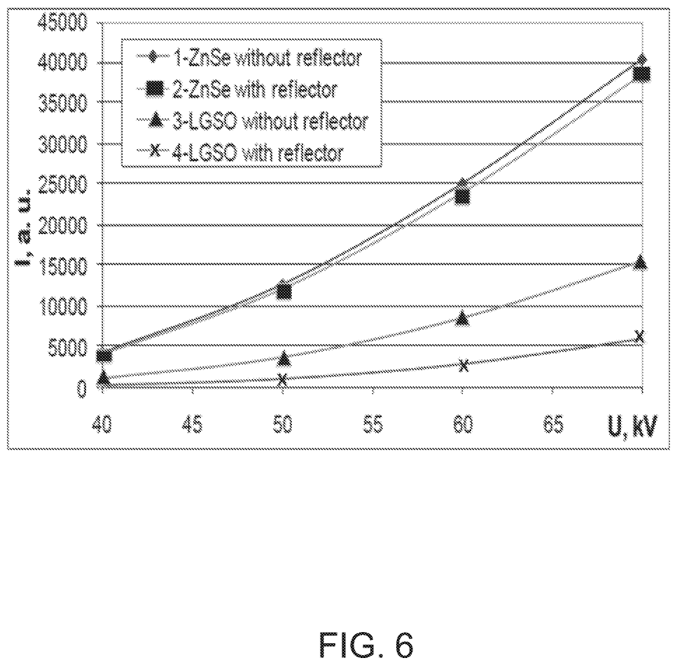

FIG. 6 is a schematic illustration of dependences of scintillation signals total intensities from different dispersed scintillating material of (ZnSe(AI) (markers 1 and 2) and scintillating material of LGSO(Ce) (markers 3 and 4) scintillators as a function of the X-ray tube voltage at constant current of 0.395 mA with a reflector between the two elements (1,3), and without a reflector (2,4) between the elements. In the setup was tested two layers of elements first layer comprising low energy sensitive scintillating material ZnSe(AL) and second layer comprising high energy scintillating material LGSO(Ce). Markers 1 and 3 illustrate a set up where a reflector material was between the layers and markers 2 and 3 illustrate a situation where no reflector was between the layers.

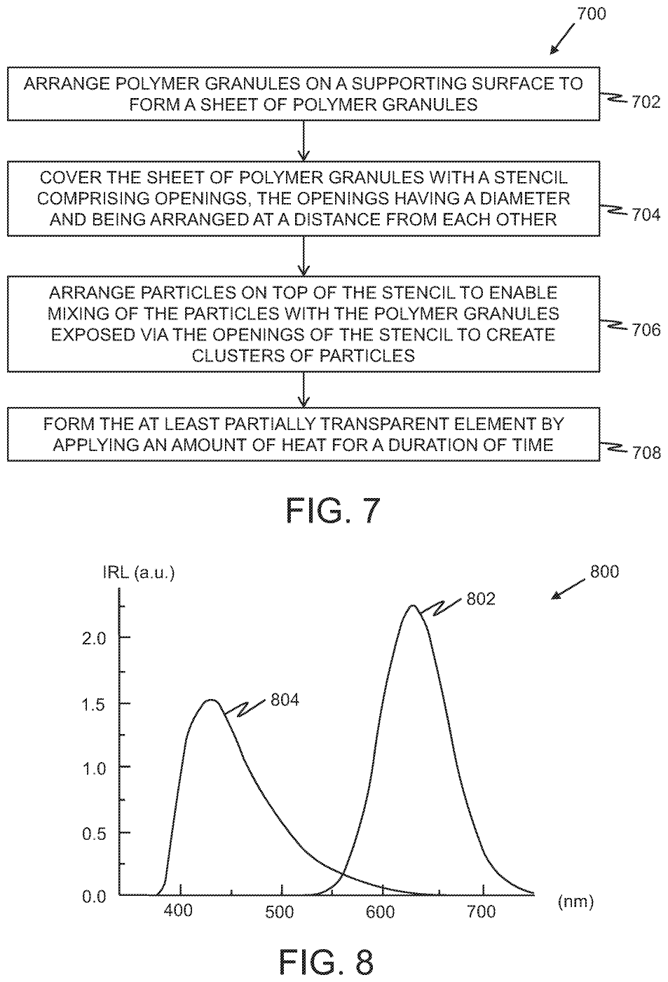

Referring to FIG. 7, illustrated is an illustration of steps of a method 700 for manufacturing a partially optically transparent element (such as the partially optically transparent element 302 of FIG. 3), in accordance with an embodiment of the present disclosure. At step 702, polymer granules are arranged on a supporting surface to form a sheet of polymer granules. At step 704, sheet of polymer granules is covered with a stencil comprising openings, the openings having a diameter and being arranged at a distance from each other. At step 706, particles are arranged on top of the stencil to enable mixing of the particles with the polymer granules exposed via the openings of the stencil to create clusters of particles. At step 708, the at least partially transparent element is formed by applying an amount of heat for a duration of time.

The steps 702 to 708 are only illustrative and other alternatives can also be provided where one or more steps are added, one or more steps are removed, or one or more steps are provided in a different sequence without departing from the scope of the claims herein. For example, in the method 700 the supporting surface used to form the sheet of polymer granules may be flat. Further, in the method 700, vibrations may be applied to the supporting surface during the manufacturing. Also, in the method 700, the at least optically partially transparent element may be formed in a form of concave, spherical or curved form factor.

FIG. 8 is a graph 800 depicting radioluminescence spectra of an apparatus for measuring radiation, in accordance with an embodiment of the present disclosure. The apparatus for measuring radiation comprises of aluminium-doped zinc selenide (ZnSe(Al)) and cerium-doped lutetium-gadolinium oxyorthosilicate (LGSO(Ce)) that is configured to convert X-ray radiation to photons having two different characteristic bands of wave-lengths. Further, aluminium-doped zinc selenide is responsive to low-energy X-ray radiation and cerium-doped lutetium-gadolinium oxyorthosilicate is responsive to high-energy X-ray radiation. As shown, curve 802 corresponds to distribution of light intensity for wavelength of emitted photons (a first characteristic band of wavelengths having maximum peak at around 620 nm and starting from 550 nm extending to 750 nm) for aluminium-doped zinc selenide and curve 804 corresponds to distribution of light intensity and wavelength of emitted photons (a second characteristic band of wavelengths having maximum peak at around 425 nm starting from 375 nm and extending to 650 nm) for cerium-doped lutetium-gadolinium oxyorthosilicate. As one can see the characteristic band wavelengths originating from different scintillating material might overlap at least partly.

Modifications to embodiments of the present disclosure described in the foregoing are possible without departing from the scope of the present disclosure as defined by the accompanying claims. Expressions such as including, comprising, incorporating, have, is used to describe and claim the present disclosure are intended to be construed in a non-exclusive manner, namely allowing for items, components or elements not explicitly described also to be present. Reference to the singular is also to be construed to relate to the plural.

1. An apparatus for measuring radiation, the apparatus comprising
an at least partially optically transparent first element, comprising at least a first group of clusters of particles, wherein
the clusters of particles of the first group are arranged at a first distance from each other;
the particles of clusters of the first group are capable of converting a first type of radiation at least partly to photons having a first characteristic band of wavelengths;
a photo detector arranged to measure light intensity emitted from the first group of clusters of particles; and
a processor configured to use the measured light intensity to determine an amount of the first type of radiation wherein the at least partially optically transparent element is a polymer sheet.

2. An apparatus according to claim 1, wherein the particles of clusters of the first group are made of a scintillating material of a first type.

3. An apparatus according to claim 1, wherein the at least partially optically transparent first element comprises a second group of clusters of particles, wherein the clusters of particles of the second group are arranged at a second distance from each other.

4. An apparatus according to claim 3, wherein the particles of clusters of the second group are capable of converting a second type of radiation at least partly to photons having a second characteristic band of wavelengths.

5. An apparatus according to claim 4, wherein the particles of clusters of the second group are made of a scintillating material of a second type.

6. An apparatus according to claim 1, further comprising
an at least partially transparent second element comprising at least a third group of clusters of particles, wherein
the clusters of particles of the third group are arranged at a third distance from each other; and
the particles of clusters of the third group are capable of converting a third type of radiation at least partly to photons having a third characteristic band of wavelengths; and wherein
the photo detector is arranged to measure light intensity emitted from the third group of the clusters of particles; and
the processor is configured to use the measured light intensity from the third group of the clusters of particles to determine an amount of the third type of radiation.

7. An apparatus according to claim 6, wherein the particles of the clusters of third group are made of a scintillating material of a third type.

8. An apparatus according to claim 6, wherein the at least partially optically transparent second element further comprises a fourth group of clusters of particles, wherein
the clusters of particles of the fourth group are arranged at a fourth distance from each other; and
the particles of clusters of the fourth group are capable of converting a fourth type of radiation at least partly to photons having a fourth characteristic band of wavelengths.

9. An apparatus according to claim 8, wherein the particles of the clusters of fourth group are made of a scintillating material of a fourth type.

10. An apparatus according to claim 1, wherein the clusters of particles are arranged in a form selected from a circle, a rectangle, a cone, a pyramid and a matrix.

11. An apparatus according to claim 1, wherein the type of radiation is selected from group of X-rays, gamma-rays, beta-rays, alpha radiation, charged particles, and neutrons.

12. An apparatus according to claim 1, wherein the scintillating material is selected from group of zinc selenide, zinc sulphide, gadolinium fine aluminium gallate, lutetium-yttrium oxyorthosilicate, lutetium-gadolinium oxyorthosilicate, cadmium telluride, and cadmium zinc telluride.

13. An apparatus according to claim 1, wherein the photo detector is arranged to measure the light intensity from at least two groups of the clusters of particles independently from each other.

14. An apparatus according to claim 1, wherein each of the clusters has a diameter of 10 nanometres-10 millimetres.

15. An apparatus according to claim 1, wherein the distance between clusters is 1-100 times of diameter of both clusters.

16. An apparatus according to claim 1, wherein the photo detector and the processor are further configured to measure timing of photons emitted from the clusters of particles.

17. A method of manufacturing an at least partially optically transparent element comprising at least two clusters of particles, the method comprising;
arranging polymer granules on a supporting surface to form a sheet of polymer granules;
covering the sheet of polymer granules with a stencil comprising openings, the openings having a diameter and being arranged at a distance from each other;
arranging particles on top of the stencil to enable mixing of the particles with the polymer granules exposed via the openings of the stencil to create clusters of particles; and
forming the at least partially transparent element by applying an amount of heat for a duration of time.

18. A method of manufacturing according to claim 17, wherein the supporting surface is flat.

19. A method of manufacturing according to claim 17, wherein the method further comprises applying vibrations to the supporting surface during the manufacturing.

20. A method of manufacturing according to claim 17, wherein the at least optically partially transparent element is further formed in a form of concave, spherical or curved form factor.
